(19) United States
(12) Patent Application Publication
(10) Pub. No.: US 2025/0381802 A1
(43) Pub. Date: Dec. 18, 2025

(54) NON-PNEUMATIC TIRE

(71) Applicant: The Goodyear Tire & Rubber Company, Akron, OH (US)

(72) Inventors: Wesley Glenn Sigler, Akron, OH (US); Francesco Sportelli, Colmar-Berg (LU)

(21) Appl. No.: 18/745,197

(22) Filed: Jun. 17, 2024

(51) Int. Cl. B60C 7/14; B60B 21/06

(52) U.S. Cl. CPC B60C 7/146; B60B 21/064; B60B 21/066

(57) ABSTRACT

The present invention is directed to a non-pneumatic tire comprising a circumferential tread band, spokes arranged radially inwards the tread band, and anchoring rails extending in an axial direction and attached to a radially inner side of the tread band along the circumferential direction. The spokes are slidably mountable to the anchoring rails in the axial direction, connecting the tread band and the spokes by mechanical interlocking. Furthermore, the present invention is directed to a non-pneumatic tire comprising on a radially inner side of a tread band axially extending anchoring portions, and two axially neighboring rows of X-shaped spokes, which are circumferentially shifted relative to each other so that each anchoring portion anchors a radially outer right leg of a spoke in a first row of the axially neighboring rows and a radially outer left leg of a spoke in a second row of neighboring rows of spokes.

### FIELD OF THE INVENTION

The present invention is directed to a non-pneumatic tire, particularly a non-pneumatic tire comprising polymer composition spokes. Furthermore, the present invention is directed to a tire rim assembly comprising a non-pneumatic tire.

### BACKGROUND OF THE INVENTION

Non-pneumatic tires provide a robust alternative to conventional pneumatic tires, particularly for environments in which tire punctures may frequently occur. However, many non-pneumatic tire constructions comprise components which are relatively complex to manufacture and/or assemble. Thus, it is desirable to provide non-pneumatic tires which can be manufactured in a cost and/or time efficient manner. While improvements have been made in this field over the past years, significant room for improvement remains.

### SUMMARY OF THE INVENTION

In a first aspect of the present invention, the invention is directed to a non-pneumatic tire comprising a circumferential tread band and a plurality of spokes arranged radially inwards the tread band for supporting the tread band. Furthermore, the tire comprises a plurality of anchoring rails extending in an axial direction of the tire and attached to a radially inner side of the tread band along the circumferential direction of the tire, wherein the spokes are slidably mountable to the anchoring rails in the axial direction to mechanically interlock the tread band and the spokes against movement in a radial direction of the tire.

In a second aspect of the present invention, the invention is directed to a non-pneumatic tire, wherein the tire comprises a radially outer tread band, a plurality of axially extending anchoring portions provided on a radially inner side of the tread band, and a plurality of spokes having an essentially X-shaped cross-section in a plane perpendicular to an axial direction of the tire. Each spoke of the plurality of spokes has a pair of radially inner legs and a pair of radially outer legs, wherein both pairs of legs are connected by a connecting portion of the spoke, wherein one of the radially outer legs is axially and slidingly mounted to one of the axially extending anchoring portions to mechanically interlock the spoke and the anchoring portion against relative radial movement. Furthermore, the spokes are arranged in at least two axially neighboring circumferential rows of spokes, wherein the axially neighboring rows of spokes are circumferentially shifted relative to each other so that each anchoring portion mechanically interlocks a radially outer right leg of a spoke in a first row of the two rows of neighboring spokes and a radially outer left leg of a spoke in a second row of the two rows of neighboring spokes, when viewed in the axial direction.

### BRIEF DESCRIPTION OF THE DRAWINGS

The invention will be described by way of example and with reference to the accompanying drawings in which:

FIG. 1 is a schematic side view of a tire rim assembly, comprising a rim and a non-pneumatic tire according to an embodiment of the present invention;

FIG. 2 is a partial schematic sideview of the tire rim assembly already shown FIG. 1;

FIG. 3 is a partial schematic perspective view of the tread band carrying a plurality of separate anchoring rails of the non-pneumatic tire already shown in FIGS. 1 and 2;

FIG. 4 is a schematic side view of an X-shaped spoke, such as of a spoke already shown in FIG. 2; and

FIG. 5 is a partial schematic perspective view of a portion of the tire rim assembly already shown in FIG. 1.

### DETAILED DESCRIPTION OF THE INVENTION

According to the first aspect, the non-pneumatic tire comprises a circumferential tread band and a plurality of spokes arranged radially inwards the tread band for supporting the tread band, and wherein the tire comprises a plurality of, preferably separately attached or separate, anchoring rails extending in an axial direction of the tire and attached to a radially inner side of the tread band along a circumferential direction of the tire. The spokes are slidably mountable (or mounted) to the anchoring rails in the axial direction to mechanically interlock the tread band and the spokes against movement in a radial direction of the tire. In other words, the spokes are connected to the anchoring rails via mechanical interlocking.

The provision of a plurality of axially extending anchoring rails allows a flexible assembly or building of the non-pneumatic tire. In particular, the number of separate anchoring rails can be adapted to different tire diameters. Moreover, the spokes can be easily mounted and/or demounted by an axially sliding connection between spokes and anchoring rails. Both, the spokes and the anchoring rails can be produced in large numbers and deployed easily for various tire sizes. It is an option to exchange spokes against spokes with different properties. Similarly, it is possible to exchange a worn tread band against a new tread band, or a summer tread band against a winter tread band, such as by axially demounting the spokes from the anchoring rails.

In one embodiment, the anchoring rails are circumferentially spaced from each other. In other words, the anchoring rails are provided circumferentially separated from each other. For instance, such a provision may save material for anchoring the spokes to the tread band. Optionally, the anchoring rails are, preferably separately, attached to the tread band by one or more adhesives. Anchoring rails may also be described as (separate) anchoring rail members.

In another embodiment, the anchoring rails comprise axially extending anchoring slots for axially receiving complementary axially extending anchoring portions of the spokes. For instance, the anchoring slots may comprise undercut surfaces, and/or the anchoring portions may comprise protrusions extending into complementary undercut surfaces of the anchoring slots.

In still another embodiment, the axially extending anchoring rails and the spokes comprise one or more polymer compositions, or consist of one or more polymer compositions. Such anchoring rails are easy to manufacture by extrusion or molding. Optionally, the anchoring rails and/or axially extending anchoring slots of the anchoring rails are at least partially clad with metal. Such metal cladding may help to reinforce the anchoring slots. In addition, or alternatively, the polymer composition may be cord and/or fiber reinforced. In addition, or alternatively, the spokes may also be cord and/or fiber reinforced.

In still another embodiment, each of the anchoring rails has one or more of: a circumferential width within a range of 1 cm to 4 cm, preferably of 1 cm to 2.5 cm; and a radial height of 0.5 cm to 3 cm, preferably of 1 cm to 2.5 cm.

In still another embodiment, the tire comprises from 30 to 200 anchoring rails, preferably from 50 to 150 anchoring rails.

In still another embodiment, the anchoring rails, extending in the axial direction, are arranged in parallel to one another and/or are spaced from one another along a circumferential direction of the tire.

In still another embodiment, the tire further comprises anchoring rail covers mountable to (one or more) axial ends of the anchoring rails to lock spokes mounted to the anchoring rails against movement in the axial direction. Such anchoring rail covers can, e.g., be attached to the anchoring rails via one or more of an adhesive connection, a press-fit connection, and mechanical interlocking, such as by a snap-fit connection. Optionally, the anchoring rail covers comprise or consist of a polymer composition, such as a thermoplastic polymer or an elastomer composition.

In still another embodiment, the tire comprises at least two axially neighboring rows of (the) spokes, extending along a circumferential direction. Optionally, each anchoring rail anchors two axially neighboring spokes. Thus, one anchoring rail may be used to anchor spokes of multiple axially adjacent, circumferential rows of spokes, which again eases production and/or assembly of the tire and its components.

In still another embodiment, each anchoring rail of the plurality of anchoring rails extends over at least 40%, preferably over at least 70%, or even more preferably over at least 80% of the maximum axial width of the tire.

In still another embodiment, each of the spokes has an essentially X-shaped cross-section in a plane perpendicular to the axial direction, and optionally comprises a pair of radially inner legs and a pair of radially outer legs, wherein both pairs of legs are optionally connected to each other by a connecting portion of the respective spoke (arranged radially between both pairs of legs). In another option, the axially neighboring rows of spokes are circumferentially shifted relative to each other, e.g., so that each anchoring rail anchors i) a right radially outer leg of a spoke in a first row of the two rows of neighboring spokes, and ii) a left radially outer leg of a spoke in a second row of the two rows of neighboring spokes, such as when viewed in the axial direction. In other words, the two rows of spokes can be described as being shifted by a circumferential distance corresponding to the circumferential distance between the circumferential centers of radially outer ends of two radially outer legs of a spoke. Preferably, each row of spokes of the tire has the same number of spokes, and/or spokes of the same shape and/or size, such as including the same radial height and/or the same circumferential width.

In still another embodiment, the circumferential distance between circumferential centers of two neighboring anchoring rails essentially corresponds to the circumferential distance between circumferential centers of radially outer ends (or end portions) of two radially outer legs of one of the spokes.

In still another embodiment, the number of anchoring rails along the circumferential direction corresponds to twice the number of spokes per row of spokes.

In still another embodiment, the spokes comprise a polymer composition (material).

In still another embodiment, one or more of the anchoring rails and the spokes comprise one or more of an elastomer composition, and a thermoplastic polymer composition.

In still another embodiment, the anchoring rails comprise or consist of metal.

In still another embodiment, the tread band comprises one or more elastomer compositions, preferably rubber compositions. It is emphasized that different components provided in the tire may comprise different polymer compositions.

In still another embodiment, the polymer compositions comprise one or more of elastomer compositions (e.g., rubber compositions) and thermoplastic polymer compositions (e.g., thermoplastic elastomer, such as thermoplastic polyester elastomer or thermoplastic polyurethane). Optionally, a polymer composition of the anchoring rails is clad with metal, such as at an interface between an anchoring portion of a respective spoke held or anchored in the anchoring rail and an anchoring slot of the anchoring rail.

In still another embodiment, the polymer composition is an elastomer composition, such as a rubber composition. Optionally, said elastomer composition (such as the rubber composition) comprises one or more of rubber (such as comprising one or more of natural rubber, synthetic polyisoprene, butadiene rubber, styrene-butadiene rubber, and butyl rubber), a filler (such as comprising one or more of carbon black and silica), resin (such as a hydrocarbon resin selected from one or more of coumarone-indene resins, petroleum hydrocarbon resins, terpene resins, styrene/alphamethylstyrene resins, terpene phenol resins, rosin derived resins and copolymers and/or mixtures thereof), accelerators, antidegradants, oils, liquid diene-based polymers, coupling agents (such as carbon black coupling agents and/or silanes), sulfur donors, and sulfur. Liquid means herein that a material is in a liquid state at 23°C. The composition may be a sulfur-curable or sulfur-cured rubber composition. Optionally, elastomer compositions, such as rubber compositions, are fiber-reinforced.

In a preferred embodiment, the polymer composition, particularly of the spokes, is fiber-reinforced.

In still another embodiment, the elastomer compositions or rubber compositions comprise 100 phr of rubber comprising one or more of natural rubber, synthetic polyisoprene, polybutadiene rubber, and styrene butadiene rubber. Preferably, the composition comprises at least 50 phr of natural rubber (such as from 50 phr to 100 phr of natural rubber, and optionally from 0 phr to 50 phr of polybutadiene rubber). Additionally, the elastomer or rubber compositions comprise a filler, preferably comprising carbon black and/or silica. For instance, such filler may be within a range of 20 phr to 150 phr, preferably within a range of 30 phr to 90 phr. Preferably, such a filler comprises predominantly carbon black. The elastomer or rubber composition may further comprise from 1 phr to 40 phr of resin, preferably including a phenolic resin. Moreover, the elastomer or rubber composition may comprise from 1 phr to 30 phr of oil, preferably from 1 phr to 20 phr of oil. Finally, the elastomer or rubber composition may typically comprise from 1 phr to 15 phr of antidegradant(s), from 0.5 phr to 10 phr of accelerator(s), from 0.1 phr to 10 phr of zinc oxide, and from 0.5 phr to 10 phr of sulfur. Further ingredients may also be present.

In still another embodiment, the spokes and/or the anchoring rails are cord and/or fiber-reinforced, wherein one or more cords and/or fibers optionally comprise one of textile, carbon, metal, bio-based, polymer, and glass fiber material.

In still another embodiment, the cord and/or fibers comprise a textile material, optionally selected from one or more of polyester (preferably, PET), polyamide (preferably, one or more of PA-6, PA-6,6, e.g., Nylon^{TM}, aromatic polyamide / aramid), and rayon. Optionally, one or more of these materials may be recycled materials. Using hybrid materials or cords and/or fibers of multiple such materials is also an option.

In still another embodiment, cords provided herein are one or more of single filament cords and multifilament cords. For instance, cords may have (maximum) diameters measured perpendicularly to the extension of the cord within a range of 0.01 mm to 2 mm, preferably within a range of 0.01 mm and 1 mm, measured after extraction of the cord from the tire.

In still another embodiment, the tread band comprises a radially outer circumferential tread portion (or tread), and a circumferential radially inner shearband, wherein the anchoring rails are one or more of co-cured and adhered by adhesive to a radially inner side of the shearband.

In still another embodiment, multiple components, members or portions mentioned herein may be one or more of adhered, cured, and co-cured to one another. For instance, it is possible to attach multiple components, members or portions comprising uncured and/or cured elastomer or rubber compositions together and co-cure them. Preferably, they are sulfur cured to each other. Peroxide cure is another option. Additionally, or alternatively, uncured rubber, primers or dips (such as RFL-based) and/or adhesives can be used to improve connection between such components, members or portions. In case of adhesive connections, suitable adhesives are commercially available and known to the person skilled in the art. They can be chosen in view of the components and/or compositions to be attached to each other. For instance, suitable adhesives include one or more of rubber based, silicone based, isocyanate based, acrylate based, cyano-acrylate based, epoxide based, polyurethane based adhesives. Preferably, the anchoring rails or portions are attached to the tread band (e.g., particularly to the shearband of the tread band) via one or more of such adhesives.

Optionally, a curing cement, such as used for retreading tires, can be used to co-cure elastomer composition portions to already cured elastomer composition portions. The use of a green rubber layer is also possible for co-curing. Optionally, one or more functional polymers may be used in one or more of the elastomer compositions and which support co-curing. Such functional groups may comprise but are not limited to one or more of isocyanate, hydroxide, halogenide, amine, amide, carboxylic, epoxide, acrylate, peroxide, and other suitable groups.

In still another embodiment, one or more components, members or portions mentioned herein may be plasma-coated before curing or co-curing them to one another. For instance, a plasma polymerized coating layer can be applied, such as by an atmospheric pressure plasma system, to at least one of the components, members or portions to be connected. In particular, such a coating can be applied in case of a connection between thermoplastic polymers and elastomer compositions (such as rubber compositions), preferably for connecting a thermoplastic polymer or thermoplastic polymer compositions of an anchoring rail to a rubber composition of the tread band, such as of its shearband.

In still another embodiment, the shearband comprises a plurality of radially stacked layers, preferably rubber composition layers. Optionally, multiple of these layers are cord reinforced rubber composition layers. Typically layers of the shearband are cured to one another, e.g., sulfur cured to one another. Shearbands as such are known in the art of non-pneumatic tires. For instance, a shearband may have from 4 to 20 radially stacked, circumferential layers.

According to the second aspect, the non-pneumatic tire comprises a radially outer tread band, a plurality of axially extending anchoring portions (e.g., axially extending anchoring rails) provided on a radially inner side of the tread band, and a plurality of spokes having an essentially X-shaped cross-section in a plane perpendicular to an axial direction of the tire. Each spoke of the plurality of spokes has a pair of radially inner legs and a pair of radially outer legs, wherein both pairs of legs are optionally connected by a connecting portion of the respective spoke, and wherein one (or, in other words, each) of the radially outer legs is axially and slidingly mounted to one of the axially extending anchoring portions to mechanically interlock (or anchor) the spoke and the anchoring portion against relative radial movement. Furthermore, the spokes are arranged in at least two axially neighboring circumferential rows of spokes, wherein the axially neighboring rows of spokes are circumferentially shifted relative to each other so that each anchoring portion mechanically interlocks (or anchors) a radially outer right leg of a spoke in a first row of the two rows of neighboring spokes and a radially outer left leg of a spoke in a second row of the two rows of neighboring spokes, when viewed in the axial direction, or, in other words, from an axial or lateral side of the tire.

Thus, the non-pneumatic tire comprising at least two rows of X-shaped spokes can be easily assembled by an axially sliding connection of the spokes with the anchoring portions. Moreover, the circumferential shift of spokes from row to row helps to provide an even stiffer and/or more robust tire, such as with respect to forces acting on the tire in cornering maneuvers.

In one embodiment, the anchoring portions of the tire are anchoring rails as mentioned in the first aspect and/or one or more of its embodiments.

In another embodiment, a tire rim assembly comprises a non-pneumatic tire according to the first aspect or the second aspect, or according to one or more of its embodiments, and a rim. Optionally, the rim has an essentially cylindrical radially outer surface with a plurality of axially extending anchoring portions, wherein the anchoring portions of the rim are complementary to axially extending anchoring portions of radially inner ends of the radially inner legs of the spokes to mechanically interlock the radial inner ends with the anchoring portions of the rim against radial movement upon axial mounting of the axially extending anchoring portions of the spokes to the axially extending anchoring portions of the rim.

Thus, single spokes can be axially mounted or demounted relative to the rim and/or the tread band. This simplifies assembly of the tire rim assembly and/or allows replacement of single spokes, e.g., in case a respective spoke has been damaged.

In one embodiment, the rim is made of one or more of polymer composition material and metal material.

In another embodiment, the axially extending anchoring portions of the rim are axially extending anchoring slots, and the radially inner ends of the spokes comprise a cross-sectional shape (in a plane perpendicular to the axial direction of the tire) complementary to the anchoring slots.

In still another embodiment of the tire, the anchoring slots have one of an undercut shape, a stepped shape, a dovetail shape, and a T-shape, e.g., in a plane parallel to an equatorial plane of the tire or perpendicular to the axial direction.

In still another embodiment, the rim comprises at least one annular flange member mountable at a lateral side (or, in other words, an axial face side) of the rim in a radially outer region of the rim to axially lock the spokes in the anchoring portions of rim.

In still another embodiment, the rim comprises one of: two annular flange members mountable to each lateral side of the rim in a radially outer region of the rim to axially lock the spokes in the anchoring portions of the rim; and an annular flange portion on a lateral side of the rim axially opposite to the lateral side at which the annular flange member is mountable, to axially lock the spokes in the anchoring portions of the rims.

In still another embodiment, the tire rim assembly further comprises rim slot covers mountable to axial ends of the anchoring slots in the rim to lock spokes mounted to the anchoring slots of the rim against movement in the axial direction. Such covers may be the same or similar to those already described for anchoring rails and/or slots adjacent the tread band. Such rim slot covers could for instance be attached to the anchoring slots of the rim via one or more of an adhesive connection, a press-fit connection, and mechanical interlocking, such as by a snap-fit connection. Optionally, the anchoring rail covers comprise or consist of one or more of metal, and a polymer composition, such as a thermoplastic polymer, or an elastomer composition.

In still another embodiment, the rim comprises a hub portion provided radially inwards the cylindrical radially outer surface, such as for mounting the rim to a vehicle. For instance, the hub portion may comprise a plurality of circumferentially arranged and/or axially extending holes, e.g., for receiving one or more of bolts and screws.

It is emphasized that the aspects, their embodiments and features thereof may be combined with one another.

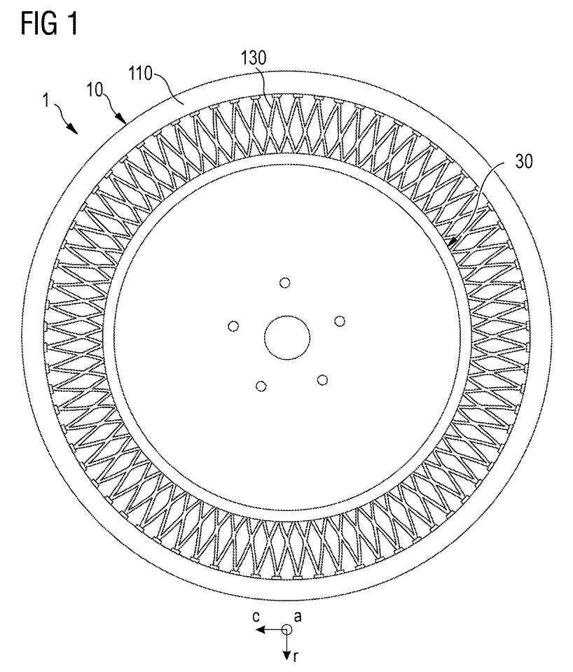

FIG. 1 shows a schematic side view of a tire rim assembly 1 according to an embodiment of the present invention. The tire rim assembly 1 comprises a non-pneumatic tire 10 mounted to a rim 30. The non-pneumatic tire 10 comprises a radially outer tread band 110 and a plurality of spokes 130 supporting the tread band 10 along the circumferential direction c.

For the sake of better understandability, the radial direction r, the axial direction a, and the circumferential direction c are indicated in FIG. 1 and partially in further Figures herein. The axial direction a is parallel to the axis of rotation of the tire. The radial direction r is perpendicular to the axial direction a. The circumferential direction c is perpendicular to the axial direction and the radial direction, and, e.g., parallel to a circumferential centerline of the tire 10 or its equatorial plane. References to one of these directions are not necessarily limited to a specific orientation, unless indicated otherwise herein.

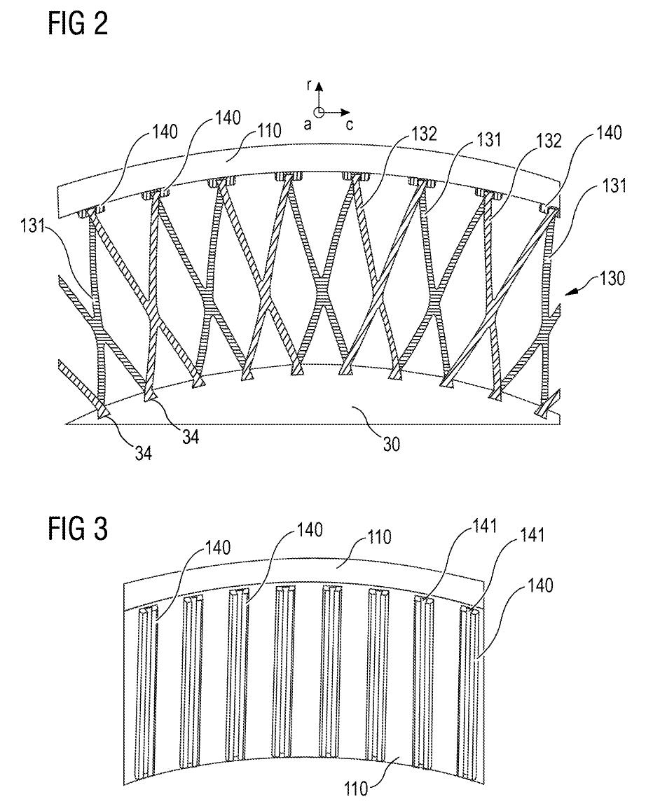

FIG. 2 shows a partial sideview of the above tire rim assembly 1. As visible in FIG. 2, the spokes 130 support the tread band 110 on a radially outer portion of the rim 30. Moreover, the tire 10 comprises a plurality of axially extending anchoring rails 140 which hold or anchor the spokes 130 by mechanical interlocking against movement in the radial direction r. On a radially inner side of the spokes 130, those are anchored to the rim 30 via mechanical interlocking by axially extending anchoring slots 34 integrally formed in the rim 30, such as by corresponding molding. In particular, the spokes 130 are axially slidable and/or mountable to the anchoring slots of the anchoring rails 140 and the anchoring slots 34 of the rim. This allows for an easy mounting of the spokes and also for a replacement of one or more damaged spokes if necessary.

In the present example, the rim 30 comprises thermoplastic polymer material but could also comprise metal material in an alternative embodiment not shown. In either case, the anchoring slots may be molded or machined into the rim. In another non-depicted embodiment, the rim comprises a plurality of axially extending anchoring rails attached to the radially outer circumference of the rim, similar to the attachment of the anchoring rails to the tread band. In still another embodiment, it is possible to provide the non-pneumatic tire with a radially inner annular portion comprising anchoring slots and/or carrying anchoring rails to hold or anchor radially inner ends of the spokes against movement in the radial direction by mechanical form fit. In such an embodiment, the rim would typically not comprise anchoring slots.

Referring again to the embodiment shown in FIG. 2, the plurality of the spokes 130 of the tire comprises two circumferential rows of X-shaped spokes 131, 132 which are provided axially beside one another. Thus, a first circumferential row of X-shaped spokes 131 is anchored by anchoring rails 140 and the anchoring slots 34 and a second axially neighboring circumferential row of X-shaped spokes 132 is anchored by the same anchoring rails 140 and anchoring slots 34. In the present embodiment, the two rows of spokes 131, 132 are circumferentially shifted as further explained herein below.

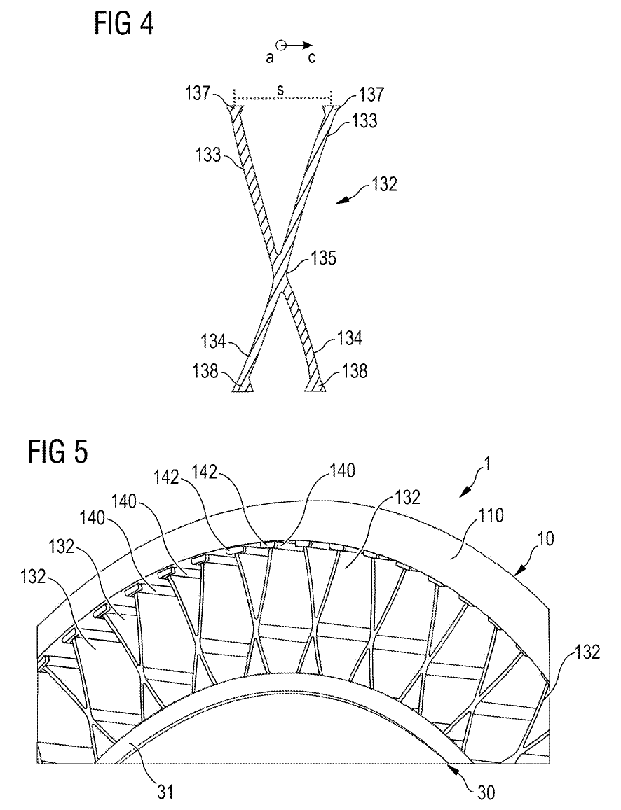

As shown in the cross-section perpendicular to the axial direction according to FIG. 4, the X-shaped spokes (here shown for one spoke 132) have two radially outer legs 133 and two radially inner legs 134. At each radially outer end of the radially outer legs, the spoke 132 has a dovetail shaped anchoring portion 137. Each of the radially inner legs 134 comprises at its radially inner end a dovetail shaped anchoring portion 138. These anchoring portions 137, 138 are complimentarily shaped with respect to the corresponding anchoring slots of said anchoring rails, and anchoring slots of the rim, respectively, so as to allow an axial insertion of the spoke 132 into the anchoring rails, and the anchoring slots of the rim, respectively. Both pairs of legs 133, 134 are connected to one another by a connecting portion 135 of the spoke 132. While the spoke 132 is shown in FIG. 4, the spokes 131 as shown in FIG. 2 have preferably the same or similar construction, cross-section and/or size. Furthermore, while dovetail shaped anchoring portions 137, 138 are shown, other suitable shapes are possible, such as T-shapes, L-shapes, stepped shapes, or other circumferentially protruding shapes interlockable with a corresponding slot, particularly against movement in the radial direction.

The distance s between circumferential centers of two radially outer anchoring portions 137 as shown in FIG. 4, is also the distance between the circumferential centers of the anchoring slots 140 shown in FIG. 2. Thus, the two axially neighboring rows of spokes 131, 132 are circumferentially shifted by said distance s. Thus, in other words, each axially extending slot of the anchoring rail 140 anchors one radially outer right leg of a spoke of a first row of spokes 131, 132 and a radially outer left leg of a spoke of a second row of spokes 132, 131. Such a shifted (or staggered) arrangement of spokes 131, 132 helps to improve tire stability and/or performance, particularly with regards to cornering maneuvers.

FIG. 3 shows a portion of the tire according to FIGS. 1 and 2, comprising the tread band 110 carrying on its circumferentially extending radially inner side or surface a plurality of separate and axially extending anchoring rails 140 comprising the anchoring slots 141 which extend in the present embodiment over essentially the whole axial width of the tread band 110. Preferably, said anchoring rails 140 are made of a polymer composition, such as a thermoplastic polymer composition, e.g., a thermoplastic polyurethane (TPU), as Arnitel^{TM} EM630 from DSM^{TM}. The anchoring rails 140 are preferably attached via an adhesive (e.g., cyanoacrylate adhesive, such as cyanoacrylate super glue) to the tread band 110. In particular, the anchoring rails 140 are not integrally formed with a circumferential or annular band herein. One advantage of such a design consists in that the number of anchoring rails can be easily varied for different tire sizes / diameters and attached separately to a radially inner side of the tread band 110. In one embodiment (not explicitly shown in FIG. 3), the tread band comprises a radially inner circumferential shearband and a radially outer circumferential tread portion. A separate attachment of the anchoring rails 140 to the radially inner side of the tread band 110 does not exclude that the separate axially extending anchoring rails 140 are applied to the radially inner side of the tread band 110 at about the same time, e.g., by a suitable application means, such as a robotic device simultaneously applying a plurality of anchoring rails in a radially outer direction onto the tread band 110. Alternatively, a robotic device may sequentially apply the anchoring rails to the tread band 110. Such a sequential application may involve rotation of the tire about its axis of rotation, e.g., from anchoring rail to anchoring rail by the distance s.

FIG. 5 shows a magnified schematic perspective view of a portion of the tire rim assembly 1 comprising the non-pneumatic tire 10 and the rim 30. In particular, the tire 10 comprises the tread band 110 carrying along the circumferential direction a plurality of separate axially extending anchoring rails 140. The anchoring rails 140 anchor a plurality of the X-shaped spokes, wherein the perspective view of FIG. 5 shows the first circumferential row of spokes 132 of two axially neighboring circumferential rows of the spokes. In the present embodiment, the axial face sides or ends of the anchoring rails 140 are covered by anchoring rail covers 142, which are preferably press fit into the anchoring slots of the anchoring rails 140. Such anchoring rail covers 142 may hold the spokes 132 in the anchoring rails 140 against movement in an axially outer direction. Furthermore, the anchoring rail covers 142 may have essentially the same size as the axial face sides of the anchoring rails 140. Furthermore, they may be removable, such as by levering the anchoring rail covers 142 out of the anchoring rail 140. The anchoring rail covers 142 may also be considered as axially mountable end caps. On a radially inner rim side of the tire 10, the spokes 132 are mounted to the rim 30 (such as shown earlier in FIG. 2) and are axially locked by a circumferential ring or annular flange member 31 of the rim 30 which is axially mountable to a circumferential radially outer portion of the rim 30. Such a flange member 31 may, e.g., be mounted to the radially outer portion of the rim, or a drum portion of the rim, by screw connections (not explicitly shown in FIG. 5). The mounted circumferential flange member 31 of the rim 30 locks the spokes 132 against axially outer movement at radially inner ends of the spokes 132. On an axially opposite side of the rim 30, there may be a second flange portion such as the flange member 31 or a circumferential flange portion integrally formed with a radially outer portion of the rim 30, or drum portion of the rim 30. Similarly, an axially opposite side of the tire 10 may also comprise individual rim slot covers, similar to the anchoring rail covers 142.

It is reemphasized that the features of the aspects and/or various embodiments mentioned herein can be combined with one another. Merely for the sake of conciseness, such combinations have not been explicitly reiterated herein.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A non-pneumatic tire comprising a circumferential tread band and a plurality of spokes arranged radially inwards the tread band for supporting the tread band,
wherein the tire further comprises a plurality of anchoring rails extending in an axial direction of the tire and attached to a radially inner side of the tread band along a circumferential direction of the tire, and wherein the spokes are slidably mountable to the anchoring rails in the axial direction to mechanically interlock the tread band and the spokes against movement in a radial direction of the tire.

2. The non-pneumatic tire according to claim 1, wherein the anchoring rails are circumferentially spaced from each other.

3. The non-pneumatic tire according to claim 1, wherein the anchoring rails comprise axially extending anchoring slots for axially receiving complementary axially extending anchoring portions of the spokes.

4. The non-pneumatic tire according to claim 3, wherein the axially extending anchoring rails and the spokes comprise one or more polymer compositions.

5. The non-pneumatic tire according to claim 1, wherein the tire further comprises anchoring rail covers mountable to axial ends of the anchoring rails to lock spokes mounted to the anchoring rails against movement in the axial direction.

6. The non-pneumatic tire according to claim 1, wherein the tire comprises at least two axially neighboring rows of spokes, wherein the rows extend along a circumferential direction and wherein each anchoring rail anchors two axially neighboring spokes.

7. The non-pneumatic tire according to claim 1, wherein each anchoring rail of the plurality of anchoring rails extends over at least 70% of the maximum axial width of the tire.

8. The non-pneumatic tire according to claim 6,
wherein each of the spokes has essentially an X-shaped cross-section in a plane perpendicular to the axial direction, and comprises a pair of radially inner legs and a pair of radially outer legs, wherein both pairs of legs are connected to each other by a connecting portion of the respective spoke, and
wherein the axially neighboring rows of spokes are circumferentially shifted relative to each other so that each anchoring rail anchors i) a right radially outer leg of a spoke in a first row of the two rows of neighboring spokes, and ii) a left radially outer leg of a spoke in a second row of the two rows of neighboring spokes, when viewed in the axial direction.

9. The non-pneumatic tire according to claim 8, wherein a circumferential distance between respective circumferential centers of two neighboring anchoring rails essentially corresponds to a circumferential distance between radially outer end portions of two radially outer legs of one of the spokes.

10. The non-pneumatic tire according to claim 6, wherein the number of anchoring rails along the circumferential direction corresponds to twice the number of spokes per row of spokes.

11. The non-pneumatic tire according to claim 1, wherein the spokes comprise a polymer composition.

12. The non-pneumatic tire according claim 1, wherein one or more of the anchoring rails and the spokes comprise one or more of an elastomer composition, and a thermoplastic polymer composition.

13. The non-pneumatic tire according to claim 1, wherein the tread band comprises a radially outer circumferential tread portion, and a radially inner circumferential shearband, wherein the anchoring rails are one or more of co-cured and adhered by adhesive to a radially inner side of the shearband.

14. A non-pneumatic tire comprising a radially outer tread band, a plurality of axially extending anchoring portions provided on a radially inner side of the tread band, and a plurality of spokes having an essentially X-shaped cross-section in a plane perpendicular to an axial direction of the tire,
wherein each spoke of the plurality of spokes has a pair of radially inner legs and a pair of radially outer legs, wherein both pairs of legs are connected by a connecting portion of the spoke,
wherein one of the radially outer legs is axially and slidingly mountable to one of the axially extending anchoring portions to mechanically interlock the spoke and the anchoring portion by mechanical form fit against relative radial movement,
wherein the spokes are arranged in at least two axially neighboring circumferential rows of spokes,
wherein the axially neighboring rows of spokes are circumferentially shifted relative to each other so that each anchoring portion mechanically interlocks a radially outer right leg of a spoke in a first row of the two rows of neighboring spokes and a radially outer left leg of a spoke in a second row of the two rows of neighboring spokes, when viewed in the axial direction.

15. A tire rim assembly comprising the non-pneumatic tire according to claim 14 and a rim,
wherein the rim has an essentially cylindrical radially outer surface with a plurality of axially extending anchoring portions, and wherein the axially extending anchoring portions of the rim are complementary to axially extending anchoring portions of radially inner ends of the radially inner legs of the spokes to mechanically interlock the radially inner ends with the anchoring portions of the rim against radial movement upon axial mounting of the axially extending anchoring portions of the spokes to the axially extending anchoring portions of the rim.

16. The tire rim assembly according to claim 15, wherein the rim is made of one or more of polymer composition material and metal material.

17. The tire rim assembly according to claim 15, wherein the axially extending anchoring portions of the rim are axially extending anchoring slots, and the anchoring portions of the radially inner ends have a cross-sectional shape complementary to the anchoring slots.

18. The tire rim assembly according to claim 17, wherein the anchoring slots have one of an undercut shape, a stepped shape, a dovetail shape, and a T-shape.

19. The tire rim assembly according to claim 15, wherein the rim comprises at least one annular flange member mountable to a lateral side of the rim in a radially outer circumferential region of the rim to axially lock the spokes in the anchoring portions of rim.

20. The tire rim assembly according to claim 15, wherein the rim comprises a hub portion radially inwards the cylindrical radially outer surface for mounting the rim to a vehicle.
